(19) United States
(12) Patent Application Publication
(10) Pub. No.: US 2022/0371405 A1
(43) Pub. Date: Nov. 24, 2022

(54) HEATER ELEMENT FOR HEATING VEHICLE INTERIOR, AND HEATER FOR HEATING VEHICLE INTERIOR

(71) Applicant: NGK Insulators, Ltd., Nagoya-City (JP)

(72) Inventors: Yukio MIYAIRI, Nagoya-City (JP); Masaaki MASUDA, Nagoya-City (JP); Yoshifumi TAKAGI, Nagoya-City (JP); Yunie IZUMI, Nagoya-City (JP); Toru HAYASE, Nagoya-City (JP)

(73) Assignee: NGK Insulators, Ltd., Nagoya-City (JP)

(21) Appl. No.: 17/817,682

(22) Filed: Aug. 5, 2022

Related U.S. Application Data
(63) Continuation of application No. PCT/JP2020/034197, filed on Sep. 9, 2020.

(30) Foreign Application Priority Data
Feb. 21, 2020 (JP) 2020-028527

(51) Int. Cl. B60H 1/22

(52) U.S. Cl. CPC B60H 1/2225; B60H 2001/00085

(57) ABSTRACT

A heater element for heating a vehicle interior includes a pillar shaped honeycomb structure portion having: an outer peripheral wall; and partition walls arranged on an inner side of the outer peripheral wall, the partition walls defining a plurality of cells, each of the cells forming a flow path from a first end face to a second end face. The outer peripheral wall and the partition walls are made of a material having PTC characteristics. The heater element further includes a dense insulating film that covers at least a part of the pillar shaped honeycomb structure portion.

### FIELD OF THE INVENTION

The present invention relates to a heater element for heating a vehicle interior, and a heater for heating a vehicle interior.

### BACKGROUND OF THE INVENTION

From a point of view of protecting the global environment, there is an increasing need for reduction of CO₂ emissions from motor vehicles. Further, from a point of view of achieving environmental standards in urban areas, there is an increasing need for zero emission of nitrogen oxides and the like from motor vehicles. To address these issues, electric vehicles are attracting attention. However, the electric vehicles cause a problem that the heat source for heating is not sufficient, because they do not have any internal combustion engine which has been conventionally used as a heat source for heating.

Therefore, for heating by effectively using the electric power of the battery, a steam compression heat pump has been used (Patent Literature 1). The steam compression heat pump compresses a medium by an electric compressor and pumps heat from cold outside air to the vehicle interior by utilizing heat absorption and heat dissipation in a phase change between a gas phase and a liquid phase. The steam compression heat pump has an advantage that electric energy can be more effectively used because an amount of heat that can be pumped is larger than the input power.

Further, also known is a heater using Joule heat generated by electric resistance during conduction of current (Patent Literature 2). In the heater using Joule heat, a heating element is arranged in a heat exchanger, and a fluid passing through the heat exchanger is heated. The heater using Joule heat is effective when rapid heating at the start of the vehicle is required or when the outside air temperature is very low. As the heating element, it is known to use a PTC material in order to prevent thermal runaway.

On the other hand, a heater using a honeycomb-shaped heater element (hereinafter referred to as “honeycomb heater”) is known in the art. For example, Patent Literature 3 discloses that a honeycomb-shaped heating element using a barium titanate-based PTC thermistor is used in fields such as a hot air heater, a dryer, and a hair dryer. Further, Patent Literature 4 describes a honeycomb structure for current-conduction heat generation, which is effective for heating an exhaust gas from a gasoline engine, a diesel engine and a combustion device. Furthermore, Patent Literature 5 also describes an electrically heatable honeycomb body for processing an exhaust gas from an internal combustion engine.

### PRIOR ART

### Patent Literatures

[Patent Literature 1] Japanese Patent Application Publication No. 2017-30724 A
[Patent Literature 2] Japanese Patent Application Publication No. 2015-519260 A
[Patent Literature 3] Japanese Utility Model Application Publication No. S54-123442 A
[Patent Literature 4] Japanese Patent No. 5261256 B
[Patent Literature 5] Japanese Patent Application Publication No. 2008-215351 A

### SUMMARY OF THE INVENTION

The present invention is specified as follows:

The present invention relates to a heater element for heating a vehicle interior, comprising a pillar shaped honeycomb structure portion having: an outer peripheral wall; and partition walls arranged on an inner side of the outer peripheral wall, the partition walls defining a plurality of cells, each of the cells forming a flow path from a first end face to a second end face,

wherein the outer peripheral wall and the partition walls comprise a material having PTC characteristics, and

wherein the heater element further comprises a dense insulating film that covers at least a part of the pillar shaped honeycomb structure portion.

Further, the present invention relates to a heater for heating a vehicle interior, comprising:

the heater element for heating the vehicle interior as described above;

an inflow pipe for communicating an outside air introduction portion or the vehicle interior with the first end face of the heater element for heating the vehicle interior;

a battery for applying voltage to the heater element for heating the vehicle interior; and

an outflow pipe for communicating the second end face of the heater element for heating the vehicle interior with the vehicle interior.

### BRIEF DESCRIPTION OF THE DRAWINGS

FIG. 1 is a schematic perspective view of a heater element according to an embodiment of the present invention;

FIG. 2 is a cross-sectional view taken along the line a-a′ in the heater element of FIG. 1;

FIG. 3 is a cross-sectional view taken along the line b-b′ in the heater element of FIG. 2;

FIG. 4 is a cross-sectional view taken along the line c-c′ in the heater element of FIG. 2;

FIG. 5 is a schematic perspective view of another pillar shaped honeycomb structure that can be used in a heater element according to an embodiment of the present invention;

FIG. 6 is a schematic perspective view of another pillar shaped honeycomb structure that can be used in a heater element according to an embodiment of the present invention;

FIG. 7 is a schematic end view illustrating an example of an assembly in which pillar shaped honeycomb structure portions are joined together; and

FIG. 8 is a schematic view illustrating an arrangement example of a heater for heating a vehicle interior according to an embodiment of the present invention.

### DETAILED DESCRIPTION OF THE INVENTION

The steam compression heat pump is superior in terms of a thermal efficiency, but the steam compression heat pump has problems that it is difficult to operate when the outside air has an extremely low temperature and it is difficult to rapidly heat a vehicle interior at the time when the vehicle is started. Therefore, it would be practical to supplementarily utilize the heater using Joule heat when rapid heating at the start of the vehicle is required or when the outside temperature is very low, while using the steam compression heat pump as the main heating device.

However, the conventional heater using Joule heat has a problem that it tends to have a larger size, and presses a space inside the vehicle. Therefore, it is desirable to provide a more compact heater. In this regard, the honeycomb heater can increase a heat transfer area per a volume, which would contribute to the miniaturization of the heater. However, the honeycomb structure for current-conduction heat generation described in Patent Literature 4 generates excessive heat because the honeycomb structure has NTC characteristics, and it is difficult to be applied as a heater for heating a vehicle interior. Further, in the technique described in Patent Literature 5, a temperature of a control element made of the PTC material does not follow the temperature of the honeycomb body, so that the effect of suppressing excessive heat generation is not sufficient for the heater for heating the vehicle interior. On the other hand, the honeycomb-shaped heating element using the PTC thermistor described in Patent Literature 3 can suppress excessive heat generation, so that it may be applicable to a heater for heating a vehicle interior.

On the other hand, when the honeycomb heater is placed in a heater for heating a vehicle interior that uses a steam compression heat pump as a main heating device, a heat exchanger (condenser and evaporator) of the steam compression heat pump is present on the upstream side, so that dew condensation water generated in the heat exchanger may disperse and adhere to the honeycomb heater. Therefore, when the honeycomb-shaped heating element described in Patent Literature 3 is used as the heater for heating the vehicle interior, the electric circuit of the honeycomb heater may be short-circuited by dew condensation water, and there is, therefore, a need for addressing this problem.

The present invention has been made to solve the above problems. An object of the present invention is to provide a heater element for heating a vehicle interior, in which the heater element using a PTC material can suppress a short circuit of an electric circuit due to moisture such as dew condensation water, and a heater for heating a vehicle interior, which is provided with such a heater element for heating the vehicle interior.

According to the present invention, it is possible to provide a heater element for heating a vehicle interior, in which the heater element using a PTC material can suppress a short circuit of an electric circuit due to moisture such as dew condensation water, and a heater for heating a vehicle interior, which is provided with such a heater element for heating the vehicle interior.

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

(1. Heater Element)

A heater element according to an embodiment of the present invention can be suitably utilized as a heater element for heating a vehicle interior of a vehicle. The vehicle includes, but not limited to, automobiles and trains. Non-limiting examples of the automobile include a gasoline vehicle, a diesel vehicle, a gas fuel vehicle using CNG (a compressed natural gas) or LNG (a liquefied natural gas), a fuel cell vehicle, an electric vehicle, and a plug-in hybrid vehicle. The heater element according to the embodiment of the present invention can be particularly suitably used for a vehicle having no internal combustion engine such as electric vehicles and electric railcars.

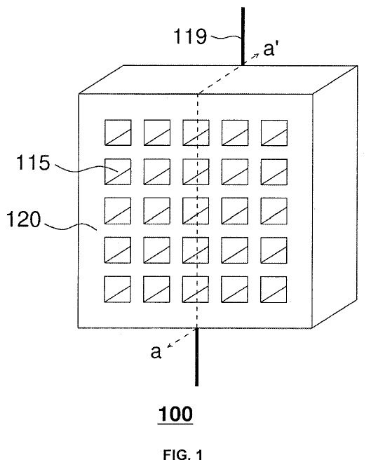

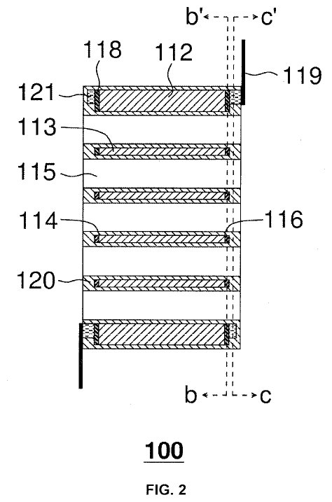

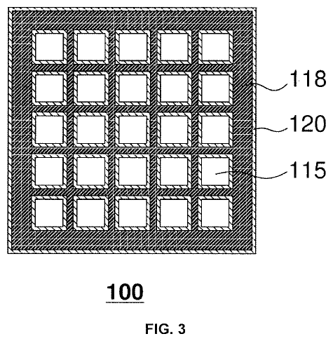

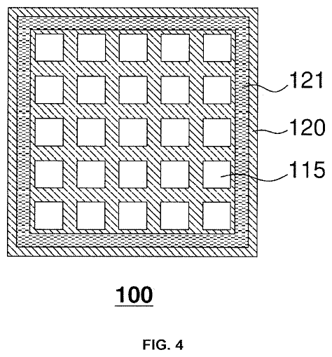

FIG. 1 is a schematic perspective view of a heater element according to an embodiment of the present invention. FIG. 2 is a cross-sectional view taken along the line a-a′ in the heater element of FIG. 1. FIG. 3 is a cross-sectional view taken along the line b-b′ in the heater element of FIG. 2. FIG. 4 is a cross-sectional view taken along the line c-c′ in the heater element of FIG. 2.

A heater element 100 includes a pillar shaped honeycomb structure portion having: an outer peripheral wall 112; and partition walls 113 arranged on an inner side of the outer peripheral wall 112, the partition walls 113 defining a plurality of cells 115, each of the cells 115 forming a flow path from a first end face 114 to a second end face 116. The heater element 100 further comprises a dense insulating film 120 that covers at least a part of the pillar shaped honeycomb structure portion. It should be noted that the perspective view of FIG. 1 shows, as an example, a case where the entire pillar shaped honeycomb structure is covered with the dense insulating film 120.

(1-1. Pillar Shaped Honeycomb Structure Portion)

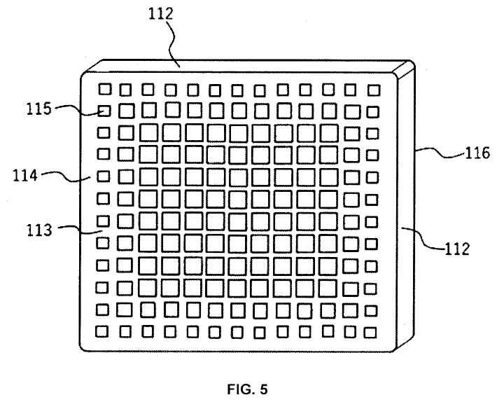

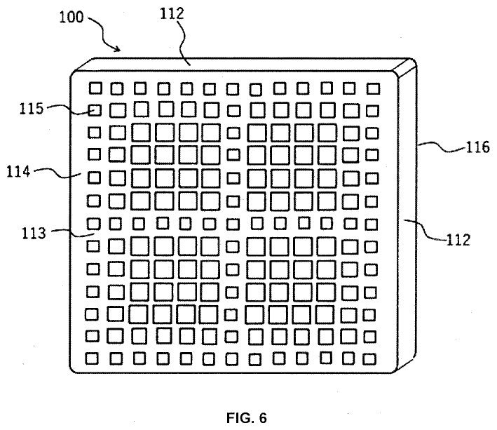

The pillar shaped honeycomb structure portion have any shape such as, for example, a pillar shape having polygonal (quadrangular (rectangular, square), pentagonal, hexagonal, heptagonal, octagonal, etc.) end faces (the first end face 114 and the second end face 116), a pillar shape having circular end faces (a cylindrical shape), and a pillar shape having oval end faces. If each end face is polygonal, the corners may be chamfered. It should be noted that the pillar shaped honeycomb structure portion shown in FIGS. 5 and 6 described below has chamfered rectangular end faces.

The shape of each cell 115 in the cross section orthogonal to the flow path direction of the cells 115 is not limited, but it may preferably be a quadrangle (rectangle, square), a hexagon, an octagon, or a combination thereof. Among these, the square and hexagon are preferable. By forming the cells 115 each having such a shape, it is possible to reduce the pressure loss when a gas passes through the pillar shaped honeycomb structure portion. It should be noted that the pillar shaped honeycomb structure portion in the heater element 100 shown in FIG. 1 has a square shape of each cell 115 in the cross section orthogonal to the flow path direction of the cells 115.

In terms of ensuring a gas flow rate, each end face of the pillar shaped honeycomb structure portion preferably has an area of 50 cm² or more, and more preferably 70 cm² or more, and even more preferably 100 cm² or more. From the viewpoint of making the heater element 100 compact, the area of each end face of the pillar shaped honeycomb structure portion is preferably 500 cm² or less, and more preferably 300 cm² or less, and further preferably 200 cm² or less. The area of each end face of the pillar shaped honeycomb structure portion can be, for example, 50 to 500 cm².

From a point of view of making the heater element 100 compact, the pillar shaped honeycomb structure portion preferably has a length (a flow path length of each cell 115) of, for example, 40 mm or less, and more preferably 30 mm or less, and further preferably 20 mm or less, and even more preferably 10 mm or less. From a point of view of ensuring heating performance and strength, the length (flow path length of each cell 115) of the pillar shaped honeycomb structure portion is preferably 3 mm or more. The length (flow path length of each cell 115) of the pillar shaped honeycomb structure portion may be, for example, 3 to 40 mm.

(1-1-1. Material of Pillar Shaped Honeycomb Structure Portion)

The outer peripheral wall 112 and the partition walls 113 of the pillar shaped honeycomb structure portion are formed of a material that can generate heat by conduction of current. Therefore, a gas such as outside air or vehicle interior air can be heated by heat transfer from the heating outer peripheral wall 112 and partition walls 113 while the gas flows in the first end face 114, passes through the plurality of cells 115, and flows out from the second end face 116.

Further, the outer peripheral wall 112 and the partition walls 113 are composed of a material having PTC (Positive Temperature Coefficient) characteristics. That is, the outer peripheral wall 112 and the partition walls 113 have a characteristic that as the temperature is increased to exceed the Curie point, a resistance value is rapidly increased, resulting in difficulty for electricity to flow. Since the outer peripheral wall 112 and the partition walls 113 have the PTC characteristics, the current flowing through them is limited when the heater element 100 becomes hot, so that excessive heat generation of the heater element 100 is prevented.

From the viewpoint of being able to generate heat when a current is conducted and of having PTC characteristics, the outer peripheral wall 112 and the partition walls 113 are preferably ceramics made of a material containing barium titanate as a main component, and more preferably ceramics made of a material containing 70% by mass of barium titanate, and even more preferable ceramics made of a material containing 90% by mass or more of barium titanate. It is preferable that the ceramics contains one or more additives such as rare earth elements in order to obtain desired PTC characteristics. The additives include semiconductor agents such as Y, La, Ce, Pr, Nd, Sm, Eu, Gd, Tb, Dy, Ho, Er, Tm, Yb and Lu; low temperature side shifters such as Sr, Sn and Zr; high temperature side shifters such as (Bi—Na), and (Bi—K); property improving agents such as Mn; metal oxides such as vanadium oxide and ytterbium oxide (in particular oxides of rare earth elements); and conductor powders such as carbon black and nickel. Other PTC materials include composite materials containing cristobalite phase SiO₂ as a base material and a conductive filler. As a substitute for the cristobalite phase SiO₂ base material, tridymite phase SiO₂, cristobalite phase AlPO₄, and tridymite phase AlPO₄ can also be used.

The material making up the outer peripheral wall 112 and the partition walls 113 preferably have a Curie point of 100° C. or more, and more preferably 110° C. or more, and even more preferably 125° C. or more, in terms of efficiently heating the air for heating. Further, the Curie point of the material making up the outer peripheral wall 112 and the partition walls 113 is preferably 250° C. or less, and preferably 225° C. or less, and even more preferably 200° C. or less, and still more preferably 150° C. or less, in terms of safety as a component placed in the vehicle interior or near the vehicle interior.

It should be noted that the Curie point of the material making up the outer peripheral wall 112 and the partition walls 113 is related to the type of the insulating film 120 covering the outer peripheral wall 112 and the partition walls 113. Details will be described below.

The Curie point of the material making up the outer peripheral wall 112 and the partition walls 113 can be adjusted by the type of shifter and an amount of the shifter added. For example, the Curie point of barium titanate (BaTIO₃) is about 120° C., but the Curie point can be shifted to the lower temperature side by substituting a part of Ba and Ti with one or more of Sr, Sn and Zr. Further, by substituting a part of Ba with Pb, the Curie temperature can be shifted to the higher temperature side.

In the present invention, the Curie point is measured by the following method. A sample is attached to a sample holder for measurement, mounted in a measuring tank (e.g., MINI-SUBZERO MC-810P, from TABAI ESPEC), and a change in electrical resistance of the sample as a function of a temperature change when the temperature is increased from 10° C. is measured using a DC resistance meter (e.g., Multimeter 3478A, from YHP). Based on an electrical resistance-temperature plot obtained by the measurement, a temperature at which the resistance value is twice the resistance value at room temperature (20° C.) is defined as the Curie point.

(1-1-2. Average Thickness of Partition Walls 113 of Pillar Shaped Honeycomb Structure)

From the viewpoint of suppressing the initial current, it is advantageous to decrease the current passage and increase the electrical resistance. Therefore, the partition walls 113 in the honeycomb structure portion preferably have an average thickness of 0.13 mm or less, and more preferably 0.10 mm or less, and even more preferably 0.08 mm or less. However, from the viewpoint of ensuring the strength of the honeycomb structure portion, the average thickness of the partition walls 113 is preferably 0.02 mm or more, and more preferably 0.04 mm or more, and even more preferably 0.06 mm or more.

As used herein, the thickness of the partition walls 113 refers to a length of a line segment in which the line segment crosses the partition wall 113 when centers of gravity of adjacent cells 115 are connected by the line segment in the cross section orthogonal to the flow path direction of the cells 115. The average thickness of the partition walls 113 refer to an average value when the thickness of the partition walls 113 is measured at 10 points.

As the thickness of the partition wall 113 is reduced, the strength of the pilar shaped honeycomb structure tends to decrease. Therefore, the strength can be supplemented by providing partition walls A having a larger thickness of the partition wall 113 and partition walls B having a smaller thickness of the partition wall 113. From the viewpoint of reinforcing the pillar shaped honeycomb structure portion, it is preferable that the partition walls 113 forming a cell group on the outermost peripheral side are at least thicker. For example, while maintaining the above range as the average thickness of the partition walls 113, the thickness of a part of the partition walls A (for example, within 60%, preferably 10% to 30% of the total number of partition walls) can preferably be 0.12 mm or more, and more preferably 0.15 mm or more, and even more preferably 0.18 mm or more, for example, 0.12 to 0.18 mm, and typically 0.15 to 0.18 mm, and the thickness of the remaining partition walls B can be 0.10 mm or less, and preferably 0.10 mm or less, and even more preferably 0.08 mm or less, and still more preferably 0.06 mm or less, for example, 0.05 to 0.10 mm, and typically 0.05 to 0.08 mm.

Here, each of FIGS. 5 and 6 show an example of a pillar shaped honeycomb structure portion in which larger thickness portions of the partition walls 113 are partially provided. In FIGS. 5 and 6, the same reference numerals as those shown in FIGS. 1 to 4 are applied to the same descriptions as those in FIGS. 1 to 4. Therefore, descriptions thereof will be omitted. In the pillar shaped honeycomb structure shown in FIG. 5, the partition walls 113 for defining the outermost cell group and the partition walls 113 for defining the outermost cell group excluding the former cell group are thicker than the other partition walls 113. In addition to the partition walls 113 described in the pillar shaped honeycomb structure portion shown in FIG. 5, in the pillar shaped honeycomb structure portion shown in FIG. 6, the partition walls 113 that define groups of cells arranged in a cross shape formed through the center of the end face of the pillar shaped honeycomb structure portion are also thicker than the other partition walls 113.

In addition to or in place to the reinforcement method as described above, the strength of the pillar shaped honeycomb structure portion can be supplemented by increasing the thickness of the outer peripheral wall 112. From the viewpoint of reinforcing the pillar shaped honeycomb structure portion, the thickness of the outer peripheral wall 112 is preferably 0.05 mm or more, and more preferably 0.06 mm or more, and further preferably 0.08 mm or more. However, from the viewpoints of increasing the electric resistance and suppressing the initial current and reducing the pressure loss during passage of the gas, the thickness of the outer peripheral wall 112 is preferably 1 mm or less, and more preferably 0.5 mm or less, and even more preferably 0.4 mm or less, and still more preferably 0.3 mm or less.

As used herein, the thickness of the outer peripheral wall 112 refers to a length of a side surface in the normal direction from a boundary between the outer peripheral side wall and the outermost peripheral side cell 115 or partition wall 113 to the side surface of the pillar shaped honeycomb structure portion in the cross section orthogonal to the flow path of the cells 115.

(1-1-3. Open Frontal Area of Pillar Shaped Honeycomb Structure Portion)

From the viewpoint of suppressing the initial current, it is advantageous to have a larger open frontal area (OFA). Therefore, the open frontal area at each end face of the honeycomb structure portion is preferably 0.81 or more, and more preferably 0.83 or more, and even more preferably 0.85 or more. Further, an increase in the open frontal area (OFA) can lead to further suppression of the ventilation resistance. However, from the viewpoint of ensuring the strength of the honeycomb structure portion, the open frontal area at each end face of the honeycomb structure portion is preferably 0.92 or less, and more preferably 0.90 or less, and even more preferably 0.88 or less.

As used herein, the open frontal area at each end face of the pillar shaped honeycomb structure portion refers to a ratio of areas of the openings of the cells 115 at each end face including the openings of the cells 115 to areas of the end face.

(1-1-4. Cell Density of Pillar Shaped Honeycomb Structure Portion)

The pillar shaped honeycomb structure portion preferably has a cell density of 93 cells/cm² or less, and more preferably 90 cells/cm² or less. By controlling the cell density to such a range, the ventilation resistance can be reduced to suppress an output of a blower. Further, the pillar shaped honeycomb structure portion preferably has a cell density of 60 cells/cm² or more, and more preferably 80 cells/cm² or more. By limiting the cell density to the above range in combination with the above-mentioned suitable range of the average thickness of the partition walls 113, it is possible to obtain a pillar shaped honeycomb structure portion suitable for rapid heating while suppressing the initial current.

As used herein, the cell density of the pillar shaped honeycomb structure portion is a value obtained by dividing the number of cells by the area of each end face of the pillar shaped honeycomb structure.

(1-1-5. Heat Transfer Coefficient of Pillar Shaped Honeycomb Structure Portion to Gas)

A value (h×S) obtained by multiplying an apparent heat transfer coefficient h (unit: W/m₂/K) by the total surface area (unit: m²) S is an index showing the heat transfer coefficient from the pillar shaped honeycomb structure portion to the gas. To improve the heating performance and reduce the size of the pillar shaped honeycomb structure portion, the lower limit of h×S is preferably 20 W/K or more, and more preferably 25 W/K or more, and even more preferably 30 W/K or more, and still more preferably 40 W/K or more. Further, from the viewpoint of avoiding destruction due to thermal shock caused by cooling the pillar shaped honeycomb structure portion by cold air, the upper limit of h×S is preferably 80 W/K or less, and more preferably 75 W/K or less, and even more preferably 70 W/K or less.

The apparent heat transfer coefficient h is calculated by the following equation (1):

h=(Nu/d)×λ (1)

In the equation (1), Nu is a fixed value of 3.63, d is a hydraulic diameter (m) of the cells 115, λ is a thermal conductivity of air (W/m/K), and λ=2.5×10⁻².

The total surface area S is calculated by the following equation (2):

S=GSA×V (2)

In the equation (2), V represents a volume (m³) of the pillar shaped honeycomb structure portion, GSA represents a surface area (m²/m³) per volume of the pillar shaped honeycomb structure portion, and GSA is determined by the following equation (3):

GSA={4(P−t)×Li}/{Li×P2} (3)

In the equation (3), Li represents a unit length (1 m), P represents an average cell pitch (m), and t represents an average thickness (m) of the partition walls 113.

The hydraulic diameter d (m) of the cells 115 is a value (d=Pt) obtained by subtracting the average thickness t (m) of the partition walls 113 from the average cell pitch P (m).

The volume of the pillar shaped honeycomb structure portion refers to a volume value measured based on external dimensions of the pillar shaped honeycomb structure portion.

The average cell pitch (P) refers to a value obtained by the following calculation. First, the areas of the end faces of the pillar shape honeycomb structure portion excluding the outer peripheral wall 112 is divided by the number of cells 115 to calculate an area per a cell. A square root of the area per a cell is calculated, and the resulting value is determined to be the average cell pitch.

The average thickness of the partition walls 113 is as described above.

(1-1-6. Joining of Pillar Shaped Honeycomb Structure Portions)

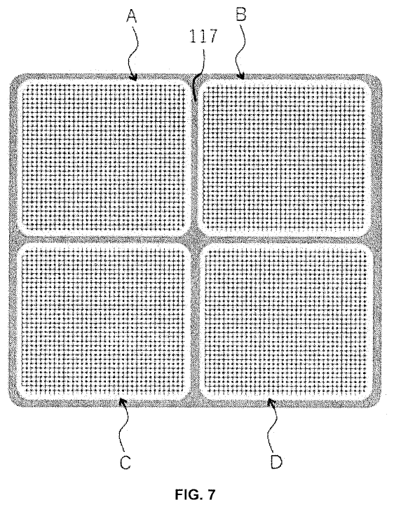

The two or more pillar shaped honeycomb structure portions can be joined together by the outer peripheral walls 112 to obtain an assembly. By joining a plurality of small pillar shaped honeycomb structure portions to form a large assembly, it is possible to increase the total cross-sectional area of the cells 115, which is important for ensuring a gas flow rate while suppressing the generation of cracks. FIG. 7 shows a schematic end view of an example of such an assembly of the pillar shaped honeycomb structure portions. FIG. 7 illustrates a schematic end view of a large assembly of pillar shaped honeycomb structure portions each having substantially square end faces, in which it is formed by joining four pillar shaped honeycomb structure portions A to D having substantially square end faces and the same size by two outer peripheral walls 112 to each other via a joining material 117 in the vertical and horizontal directions.

The joining material 117 for joining the outer peripheral walls 112 of the pillar shaped honeycomb structure portions A to D that can be used herein includes, but not limited to, a paste obtained by adding a solvent such as water to a ceramic material. The joining material 117 may contain ceramics having PTC characteristics, or may contain the same ceramics as that of the outer peripheral wall 112 and the partition walls 113. In addition to the role of joining the pillar shaped honeycomb structure portions A to D, the joining material 117 can also be used as an outer peripheral coating material for the entire large assembly after joining the pillar shaped honeycomb structure portions A to D.

(1-2. Dense Insulating Film 120)

The dense insulating film 120 plays a role of suppressing a short circuit of an electric circuit in the heater element 100 when moisture such as dew condensation water adheres to the heater element 100.

The dense insulating film 120 may cover a portion to which moisture such as dew condensation water adheres. The dense insulating film 120 preferably covers at least one selected from the outer surface of the outer peripheral wall 112, the surfaces of the flow paths, the first end face 114 and the second end face 116 of the pillar shaped honeycomb structure portion.

As used herein, the dense insulating film 120 refers to the insulating film 120 having a lower porosity. The porosity of the insulating film 120 is preferably 5% or less, and preferably 4% or less, and more preferably 3% or less. The porosity in such a range can stably suppress the passage of water through the insulating film 120.

(1-2-1. Material of Dense Insulating Film 120)

The dense insulating film 120 is formed of a material having an insulating property.

Non-limiting examples of the material having the insulating property that can be used herein include resins (polyimide resins, polyamide resins, polyamideimide resins, fluororesins, phenol resins, silicone resins, epoxy resins, furan resins, poly(fluorinated vinylidene), poly(phenylene sulfide), polyetherimide, polysulfone, polyamideimide, and the like), glass, ceramics, and the like. Examples of ceramics include alumina, mullite, and spinel.

When the outer peripheral wall 112 and the partition walls 113 are made of a material having a Curie point of 150° C. or less, the level of heat resistance required for the dense insulating film 120 is decreased. Therefore, it is possible to select the resin as the material of the dense insulating film 120. The resin includes a fluororesin such as polytetrafluoroethylene, and a polyimide resin, from the viewpoint of insulating properties and heat resistance.

On the other hand, when the outer peripheral wall 112 and the partition walls 113 are made of a material having a Curie point of more than 150° C., the level of heat resistance required for the dense insulating film 120 is increased. Therefore, it is preferable to select glass or ceramics as the material of the dense insulating film 120.

(1-2-2. Average Thickness of Dense Insulating Film 120)

The dense insulating film 120 preferably has an average thickness of 100 μm or less, and more preferably 50 μm or less, and even more preferably 10 μm or less. By controlling the average thickness to such a range, an influence on the heat transferability to the gas is reduced, and the pressure loss is difficult to increase. On the other hand, if the average thickness of the dense insulating film 120 is too low, the effect of suppressing the short circuit in the electric circuit may not be sufficiently obtained. Therefore, the average thickness of the dense insulating film 120 is preferably 0.1 μm or more, and more preferably 0.5 μm or more, and even more preferably 1.0 μm or more.

As used herein, the thickness of the dense insulating film 120 refers to a length in a direction perpendicular to a substrate on which the dense insulating film 120 is formed (the outer surface of the outer peripheral wall 112, the surfaces of the flow paths, the first end face 114 and the second end face 116), in a cross section orthogonal to the flow path direction of the cells 115. The average thickness of the dense insulating film 120 refers to an average value when the thickness of the insulating film 120 is measured at 10 points.

(1-3. Electrode Layer 118)

The heater element 100 according to the embodiment of the present invention can have electrode layers 118 on the surfaces of the outer peripheral wall 112 and the partition walls 113 on the first end face 114 and the second end face 116 (see FIGS. 2 and 3).

As for the electrode layer 118, it is preferable to provide the electrode layer 118 on each end face without blocking the cells 115, and it is more preferable to provide the electrode layer 118 on the entire end face without blocking the cells 115.

The electrode layer 118 may contain, for example, at least one selected from Cu, Ag, Al, and Si. It is also possible to use an ohmic electrode layer capable of ohmic contact with the outer peripheral wall 112 and/or the partition walls 113 which have the PTC characteristics. The ohmic electrode layer contains, for example, at least one selected from Au, Ag and In as a base metal, and contains at least one selected from Ni, Si, Ge, Sn, Se and Te for n-type semiconductors as a dopant.

When the heater element 100 according to the embodiment of the present invention has the electrode layer 118, it is preferable that at least a part, preferably the whole of the electrode layer 118, is covered with the insulating film 120. Such a structure can suppress the short circuit of the electric circuit when moisture such as dew condensation water adheres to the heater element 100.

(1-4. Conductive Member 121)

The heater element 100 according to the embodiment of the present invention may have a conductive member 121 connectable to an external power source in at least a part of the electrode layer 118 (see FIGS. 2 and 4).

It is preferable that the conductive member 121 is electrically connected to the electrode layer 118. That is, it is preferable that the conductive member 121 and the electrode layer 118 are in contact with each other, and it is preferable that the insulating film 120 does not intervene in the contact surface of the conductive member 121 with the electrode layer 118.

The conductive member 121 is preferably arranged on the electrode layer 118 provided on the outer peripheral wall 112 of the first end face 114 and the second end face 116. Such a structure can allow the entire electrode layer 118 to be efficiently energized.

The conductive member 121 has a plate shape and is formed of a material having good conductivity. For example, the conductive member 121 is formed of a metal such as a copper plate or a stainless steel plate.

When the heater element 100 according to the embodiment of the present invention has the conductive member 121, it is preferable that at least a part, preferably the whole of the conductive member 121 is covered with the insulating film 120. Such a structure can suppress the short circuit of the electric circuit when moisture such as dew condensation water adheres to the heater element 100.

A part of the conductive member 121 is exposed on the surface, and that part is connected to an electric wire 119 from the external power source. The electric wire 119 can be connected to the conductive member 121 by diffusion bonding, a mechanical pressurizing mechanism, welding, or the like, and power can be supplied from a battery, for example, via the electric wire 119.

(1-5. Method for Using Heater Element 100)

The heater element 100 according to the embodiment of the present invention can generate heat by applying a voltage between a pair of electrode layers 118 arranged on the end faces, for example. For the applied voltage, it is preferable to apply a voltage of 200 V or more, and it is more preferable to apply a voltage of 250 V or more, from the viewpoint of rapid heating. As described above, the heater element 100 according to the embodiment of the present invention is highly safe because the initial current can be suppressed even if a high voltage is applied. Further, since safety specifications do not become severe, equipment around the heater can be manufactured at lower costs.

When the heater element 100 generates heat due to the application of the voltage, the gas can be heated by allowing the gas to flow through the cells 115. A temperature of the gas flowing into the cells 115 can be, for example, −60° C. to 20° C., and typically −10° C. to 20° C.

(1-6. Method for Producing Heater Element 100)

Next, a method for producing the heater element 100 according to an embodiment of the present invention will be illustratively described. First, a raw material composition containing a dispersion medium and a binder is mixed with a ceramic raw material and kneaded to prepare a green body, which is then extruded to prepare a honeycomb formed body. To the raw material composition may optionally be added additives such as a dispersant, a semiconductor agent, a shifter, a metal oxide, a property improving agent, and a conductor powder. In the extrusion, a die having a desired overall shape, cell shape, partition wall thickness, cell density and the like can be used.

The ceramic raw material is a raw material for a portion that will remain after firing and make up the skeleton of the honeycomb structure portion as ceramics. The ceramic raw material can be provided, for example, in the form of powder. The ceramic raw material that can be used herein include oxides such as TIO₂ and BaCO₃ which are main components of barium titanate, and carbonate raw materials. Also, as the semiconductor agent such as Y, La, Ce, Pr, Nd, Sm, Eu, Gd, Tb, Dy, Ho, Er, Tm, Yb and Lu, the low temperature side shifter such as Sr, Sn and Zr, the high temperature side shifter such as (Bi—Na), (Bi—K), and the property improving agent such as Mn, oxides and/or carbonates of these, or oxalates that will form oxides after firing, may be used. Conductor powder such as carbon black and nickel may be added to control conductivity. The addition of the alkali metal element of Na or K can also be used in the form of a binder containing the alkali metal element.

Further, for example, after adding La (NH₃)₃.6H₂O to the raw material powder such as TiO₂ and BaCO₃, a dispersant and a binder can be further added, and blended so as to have BaO (50.3 mol %), TiO₂ (49.6 mol %), La₂O₃ (0.05 mol %), K₂O (0.033 mol %), and Na₂O (0.002 mol %) as a fired body, thereby providing a lead-free honeycomb structure portion. However, it is not limited to the composition, and the blending can be carried out so as to have 90% by mass or more of ceramics having a compositional formula represented by the following formula, thereby providing a honeycomb structure portion which contains rare earth elements and alkali metal elements and does not use lead:

(Ba_{1-x-y}A1ₓA2_{y})TiO₃

In the formula, A1 represents one or more rare earth elements, A2 represents one or more alkali metal elements, 0.001≤x≤0.01, 0≤y≤0.01, 0.001≤x+y≤0.02.

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. Further, the binder content is preferably 4 parts by mass or more, and more preferably 5 parts by mass or more, and 6 parts by mass, based on 100 parts by mass of the ceramic raw material, in terms of increasing the strength of the honeycomb formed body. The binder content is preferably 9 parts by mass or less, and more preferably 8 parts by mass or less, and even more preferably 7 parts by mass or less, based on 100 parts by mass of the ceramic raw material, in terms of suppressing the generation of tearing due to abnormal heat generation in the firing step. The binder may be used alone, or in combination of two or more.

The dispersant that can be used herein includes surfactants such as ethylene glycol, dextrin, fatty acid soaps, and polyalcohol. The dispersant may be used alone or in combination of two or more. The content of the dispersant is preferably 0 to 2 parts by mass based on 100 parts by mass of the ceramic raw material.

The resulting honeycomb formed body is then dried. The drying step may employ, for example, a conventionally known drying method such as hot air drying, microwave drying, dielectric drying, drying under reduced pressure, drying in vacuum, and freeze drying. Among these, a drying method that combines the hot air drying with the microwave drying or dielectric drying is preferable in that the entire formed body can be rapidly and uniformly dried.

The dried honeycomb formed body can be then fired to produce a heater element having a pillar shaped honeycomb structure portion. Prior to the firing, a degreasing step may be carried out to remove the binder. The firing conditions can be appropriately determined depending on the material of the honeycomb formed body. For example, when the material of the honeycomb formed body contains barium titanate as a main component, the firing temperature is preferably 1100 to 1400° C., and more preferably 1200 to 1300° C. The firing time is preferably about 1 to 4 hours.

An atmosphere for carrying out the degreasing step can be, for example, an air atmosphere, an inert atmosphere, or a reduced pressure atmosphere. Among these, the inert atmosphere and the reduced pressure atmosphere are preferable because they prevent insufficient sintering due to oxidation of the raw material and easily reduce the oxide contained in the raw material.

The firing furnace is not particularly limited, but an electric furnace, a gas furnace, or the like can be used.

The electrode layers 118 are formed on the first end face 114 and the second end face 116 of the pillar shaped honeycomb structure portion thus obtained. The electrode layers 118 can be formed by a metal deposition method such as sputtering, vapor deposition, electrolytic deposition, and chemical deposition. Further, the electrode layers 118 can also be formed by applying an electrode paste and then baking the electrode paste. Further, the electrode layers 118 can also be formed by thermal spraying. The electrode layer 118 may be a single layer, but may be a plurality of layers having different compositions. When the electrode layer 118 is formed by the above method, the cells 115 can be prevented from being blocked by setting the thickness of the electrode layer 118 so as not to be excessively large. For example, it is preferable that the thickness of each electrode layer 118 is from about 5 to 30 μm for baking of the electrode paste, from about 100 to 1000 nm for dry plating such as sputtering and vapor deposition, from about 10 to 100 μm for thermal spraying, or from about 5 to 30 μm for wet plating such as electrolytic precipitation and chemical precipitation.

The conductive members 121 are arranged at predetermined positions on the electrode layers 118 and joined together. The joining method is not particularly limited, and diffusion joining, a mechanical pressurizing mechanism, welding, or the like can be used.

The dense insulating film 120 is then formed on a predetermined surface of the pillar shaped honeycomb structure portion in which the electrode layers 118 and the conductive members 121 are arranged. A method for forming the dense insulating film 120 may select a method known in the art depending on the type of material used. Specifically, CVD, PVD, immersion coating, spray coating and the like can be used. Further, when the ceramics is selected as the material of the dense insulating film 120, the ceramic film may be formed by carrying out a dip coating with a slurry of the ceramic raw material, followed by a heat treatment.

(2. Heater for Heating Vehicle Interior)

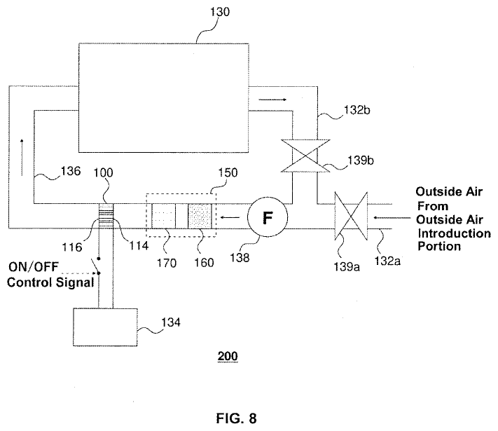

FIG. 8 is a schematic view showing an arrangement example of a heater for a vehicle interior according to an embodiment of the present invention.

A heater 200 for heating a vehicle interior according to the embodiment of the present invention includes: a heater element 100; an inflow pipe 132 (132a, 132b) for communicating an outside air introduction portion or a vehicle interior 130 with the first end face 114 of the heater element 100; a battery 134 for applying a voltage to the heater element 100; and an outflow pipe 136 for communicating the second end face 116 of the heater element 100 with the vehicle interior 130.

The heater element 100 can be configured to energize and heat the heater element 100 by connecting to the battery 134 via an electric wire 119 and turning on a power switch in the middle of the wiring, for example.

Disposed on the upstream side of the heater element 100 can be a vapor compression heat pump 150. In the heater 200 for heating the vehicle interior, the vapor compression heat pump 150 is configured as a main heating device, and the heater element 100 is configured as an auxiliary heater. The vapor compression heat pump 150 can be provided with a heat exchanger. The heat exchanger includes: an evaporator 160 that functions to absorb heat from the outside during cooling to evaporate a refrigerant; and a condenser 170 that functions to liquefy a refrigerant gas to release heat to the outside during heating. When the steam compression heat pump 150 is operated, dew condensation water is generated in the heat exchanger of the steam compression heat pump 150. The dew condensation water disperses and adheres to the heater element 100 on the downstream side due to the flow of air. As described above, at least a part of the pillar shaped honeycomb structure portion is covered with the dense insulating film 120, so that the heater element 100 is difficult to cause the short circuit in the electric circuit due to the dew condensation water, whereby the heater element 100 can be stably operated as an auxiliary heater. It should be noted that the vapor compression heat pump 150 is not particularly limited, and a vapor compression heat pump known in the art can be used.

On the upstream side or the downstream side of the heater element 100, a blower 138 can be installed. In terms of ensuring safety by arranging high-voltage parts as far as possible from the vehicle interior 130, the blower 970 is preferably installed on the upstream side of the heater element 100. As the blower 138 driven, air flows into the heater element 100 from the inside or outside of the vehicle interior 130 through the inflow pipe 132 (132a, 132b). The air is heated while passing through the heating 100 that is generating heat. The heated air flows out from the heater element 100 and is delivered into the vehicle interior 130 through the outflow pipe 136. The outlet of the outflow pipe 136 may be arranged near the feet of occupants so that the heating effect is particularly high even in the vehicle interior 130, or the pipe outlet may be arranged in a seat to warm the seat from the inside, or the pipe outlet may be arranged near a window to have an effect of suppressing fogging of the window.

The heater 200 for heating the vehicle interior includes the inflow pipe 132a for communicating the outside air introduction portion with the first end face 114 of the heater element 100. Further, the heater 200 for heating the vehicle interior includes the inflow pipe 132b for communicating the vehicle interior 130 with the first end face 114 of the heater element 100. The inflow pipe 132a and the inflow pipe 132b merge in the middle. The inflow pipe 132a and the inflow pipe 132b can be provided with valves 139 (139a,139b), respectively, on the upstream side of the confluence. By controlling the opening and closing of the valves 139 (139a, 139b), it is possible to switch between a mode where the outside air is introduced into the heater element 100 and a mode where the air in the vehicle interior 130 is introduced into the heater element 100. For example, the opening of the valve 139a and the closing of the valve 139b results in the mode where the outside air is introduced into the heater element 100. It is also possible to open both the valve 139a and the valve 139b to introduce the outside air and the air in the vehicle interior 130 into the heater element 100 at the same time.

### DESCRIPTION OF REFERENCE NUMERALS

100 heater element
112 outer peripheral wall
113 partition wall
114 first end face
115 cell
116 second end face
117 joining material
118 electrode layer
119 electric wire
120 insulating film
121 conductive member
130 vehicle interior
139 (139a, 139b) valve
132 (132a, 132b) inflow pipe
134 battery
136 outflow pipe
138 blower
150 steam compression heat pump
160 evaporator
170 condenser
200 heater for heating vehicle interior

1. A heater element for heating a vehicle interior, comprising a pillar shaped honeycomb structure portion having: an outer peripheral wall; and partition walls arranged on an inner side of the outer peripheral wall, the partition walls defining a plurality of cells, each of the cells forming a flow path from a first end face to a second end face,
wherein the outer peripheral wall and the partition walls comprise a material having PTC characteristics, and
wherein the heater element further comprises a dense insulating film that covers at least a part of the pillar shaped honeycomb structure portion.

2. The heater element for heating the vehicle interior according to claim 1, wherein the insulating film has an average thickness of 100 μm or less.

3. The heater element for heating the vehicle interior according to claim 1, wherein the insulating film has a porosity of 5% or less.

4. The heater element for heating the vehicle interior according to claim 1, wherein at least one selected from an outer surface of the outer peripheral wall, surfaces of the flow paths, the first end face and the second end face is covered with the insulating film.

5. The heater element for heating the vehicle interior according to claim 1, wherein the partition walls have an average thickness of 0.13 mm or less.

6. The heater element for heating the vehicle interior according to claim 1, wherein the heater has a cell density of 93 cells/cm² or less.

7. The heater element for heating the vehicle interior according to claim 1, wherein the outer peripheral wall and the partition walls comprise a material containing barium titanate as a main component.

8. The heater element for heating the vehicle interior according to claim 1, wherein the outer peripheral wall and the partition walls comprise a material having a Curie point of 150° C. or less.

9. The heater element for heating the vehicle interior according to claim 1, further comprising electrode layers on surfaces of the outer peripheral wall and the partition walls on the first end face and the second end face.

10. The heater element for heating the vehicle interior according to claim 9,
wherein a conductive member connectable to an external power source is arranged on at least a part of the electrode layers, and
wherein the conductive member and the electrode layer are electrically connected to each other.

11. The heater element for heating the vehicle interior according to claim 10, wherein at least a part of the electrode layers and the conductive member is covered with the insulating film.

12. A heater for heating a vehicle interior, comprising:
the heater element for heating the vehicle interior according to claim 1;
an inflow pipe for communicating an outside air introduction portion or the vehicle interior with the first end face of the heater element for heating the vehicle interior;
a battery for applying voltage to the heater element for heating the vehicle interior; and
an outflow pipe for communicating the second end face of the heater element for heating the vehicle interior with the vehicle interior.

13. The heater for heating the vehicle interior according to claim 12, wherein the heater for heating the vehicle interior is a heater for heating a vehicle interior having a steam compression heat pump configured as a main heating device.

14. The heater for heating the vehicle interior according to claim 13, wherein a heat exchanger of the steam compression heat pump is arranged on an upstream side of the heater element for heating the vehicle interior.
